(19) United States
(12) Patent Application Publication
(10) Pub. No.: US 2021/0186020 A1
(43) Pub. Date: Jun. 24, 2021

(54) AGRICULTURAL COMPOSITIONS AND METHODS OF USE THEREOF

(71) Applicant: Valent U.S.A. LLC, San Ramon, CA (US)

(72) Inventors: Eduardo Chagas Ferreira d Silva, Savoy, IL (US); John Andrew Pawlak, Lansing, MI (US)

(21) Appl. No.: 17/123,584

(22) Filed: Dec. 16, 2020

Related U.S. Application Data
(60) Provisional application No. 62/949,642, filed on Dec. 18, 2019.

(51) Int. Cl. A01N 43/54; A01N 37/10

(52) U.S. Cl. CPC A01N 43/54; A01N 37/10

(57) ABSTRACT

The present invention relates to an agricultural composition comprising a protoporphyrinogen oxidase (PPO) inhibitor, one or more fertilizers comprising a sugar alcohol selected from the group consisting of mannitol and sorbitol and optionally, one or more auxin herbicides. The present invention further relates to a method of controlling weeds comprising applying concurrently or sequentially a PPO inhibitor and one or more fertilizers comprising a sugar alcohol selected from the group consisting of mannitol and sorbitol, and optionally one or more auxin herbicides to the weeds or an area in need of weed control.

### FIELD OF THE INVENTION

The present invention relates to an agricultural composition comprising a protoporphyrinogen oxidase (PPO) inhibitor, one or more fertilizers comprising a sugar alcohol selected from the group consisting of mannitol and sorbitol and optionally, one or more auxin herbicides. The present invention further relates to a method of controlling weeds comprising applying concurrently or sequentially a PPO inhibitor and one or more fertilizers comprising a sugar alcohol selected from the group consisting of mannitol and sorbitol, and optionally one or more auxin herbicides to the weeds or an area in need of weed control.

### BACKGROUND OF THE INVENTION

Unwanted plants, such as weeds, reduce the amount of resources available to crop plants and can have a negative effect on crop plant yield and quality. For example, a weed infestation reportedly was responsible for an 80% reduction in soybean yields. Bruce, J. A., and J. J. Kells, Horseweed (Conyza Canadensis) control in no-tillage soybeans (Glycine max) with preplant and preemergence herbicides, Weed Technol, 1990, 4, 642-647. Unwanted plants in crop plant environments include broadleaves, grasses and sedges. To save time, money and resources, grass herbicides are often mixed with broadleaf herbicides to control a range of weeds. Further, to combat herbicide resistance multiple herbicides having different modes of action may be applied together.

As mentioned above, one way to control multiple weeds is to apply multiple herbicides sequentially or concurrently. However, when applying multiple herbicides, care must be taken to ensure that each of the herbicides are stable in their composition and effective when combined in either a formulation, a tank mix or after application.

Protoporphyrinogen oxidase (“PPO”) inhibitors are herbicides that primarily control broadleaf weeds. PPO inhibitors create highly toxic molecules upon contact with the weed that result in destruction of plant tissue. PPO inhibitors are also effective against some grasses.

Auxin herbicides primarily control broadleaf weeds. Auxin herbicides are plant growth regulators that mimic auxin and result in uncontrolled growth and death. These herbicides have been used successfully for over 60 years to control broadleaf weeds in cereal crops. Auxin herbicides are not effective against grasses.

Accordingly, there is a need in the art for a composition containing PPO inhibitors that is effective when combined with auxin herbicides to save time, money and resources. This composition should be stable and effective upon application.

### SUMMARY OF THE INVENTION

The present invention is directed to an agricultural composition comprising a protoporphyrinogen oxidase (“PPO”) inhibitor, one or more fertilizers comprising a sugar alcohol selected from the group consisting of mannitol and sorbitol and optionally, one or more auxin herbicides.

The present invention is further directed to a method of controlling weeds comprising applying concurrently or sequentially a PPO inhibitor and o one or more fertilizers comprising a sugar alcohol selected from the group consisting of mannitol and sorbitol, and optionally one or more auxin herbicides to the weeds or an area in need of weed control.

### DETAILED DESCRIPTION OF THE INVENTION

The Applicant has unexpectedly discovered that the addition of one or more fertilizers comprising a sugar alcohol selected from the group consisting of mannitol and sorbitol to agricultural compositions containing a protoporphyrinogen oxidase inhibitor (“PPO inhibitor”) provides stable composition and effective application when combined with auxin herbicides.

In one embodiment, the present invention is directed to an agricultural composition comprising a PPO inhibitor and one or more fertilizers comprising a sugar alcohol selected from the group consisting of mannitol and sorbitol.

As used herein the term “protoporphyrinogen oxidase inhibitor” or “PPO inhibitors” refers, but is not limited to, any compound capable of inhibiting the oxidation of protoporphyrinogen through interaction with the protoporphyrinogen oxidase enzyme, including those compounds not yet discovered or synthesized. Current PPO inhibitors include, but are not limited to, diphenylethers such as acifluorfen-sodium, bifenox, chlornitrofen, chlomethoxyfen, ethyoxyfen-ethyl, fluoroglycofen-ethyl, fomesafen, lactofen and oxyfluorfen, N-phenylphthalimides such as cinidon-ethyl, flumiclorac and flumioxazin, oxadiazoles such as oxadiargyl and oxadiazon, oxazolidinediones such as pentoxazone, phenylpyrazoles such as fluazolate and pyraflufen-ethyl, pyrimidindiones such as benzfendizone, butafenacil and saflufenacil, thiadiazoles such as fluthiacet-methyl and thidiazimin, triazolinones such as azafenidin, carfentrazone-ethyl and sulfentrazone and others such as flufenpyr-ethyl, profluazol and pyraclonil.

In a preferred embodiment the PPO inhibitor is selected from the group consisting of is selected from the group consisting of ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate, flumioxazin, lactofen, fomesafen, saflufenacil, sulfentrazone and trifludimoxazin. In a more preferred embodiment, the PPO inhibitor is ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate.

In another preferred embodiment, the PPO inhibitor may be present in compositions of the present invention at a concentration from about 0.1% to about 99.9% w/v, more preferably from about 1% to about 99% w/v.

In another preferred embodiment, the one or more fertilizers comprising a sugar alcohol selected from the group consisting of mannitol and sorbitol further comprise nitrogen and iron. Manni-Plex® FE is a mannitol comprising fertilizer that further comprises 5% w/v nitrogen and 5% w/v iron.

In another preferred embodiment, the one or more fertilizers comprising a sugar alcohol selected from the group consisting of mannitol and sorbitol may be present in compositions of the present invention at a concentration from about 0.1% to about 99.9% w/v, more preferably from about 1% to about 99% w/v.

In another embodiment, the compositions of the present invention further comprise one or more auxin herbicides.

In a preferred embodiment, the one or more auxins is selected from the group consisting of dicamba, 2,4-D, dichloroprop, (4-chloro-2-methylphenoxy)acetic acid (MCPA), 4-(4-chloro-2 methylphenoxy)butanoic acid (MCPB), mecoprop, picloram, quinclorac, triclopyr, fluroxypyr, picloram, aminopyralid, clopyralid and aminocyclopyrachlor and agricultural acceptable salts and esters thereof. In a more preferred embodiment, the one or more auxins is a salt of dicamba. In an even more preferred embodiment, the salt of dicamba is selected from the group consisting of dicamba-biproamine, dicamba-diglycolamine, and dicamba-tetrabutylamine.

In another preferred embodiment, the one or more auxins may be present in compositions of the present invention at a concentration from about 0.1% to about 99.9% w/v, more preferably from about 1% to about 99% w/v.

The compositions of the present invention may further comprise one or more excipients selected from the group consisting of solvents, anti-caking agents, stabilizers, anti-foaming agents, slip agents, humectants, dispersants, wetting agents, thickening agents, emulsifiers, anti-freeze agents and preservatives. Other components that enhance the biological activity of these ingredients may optionally be included.

The compositions of the present invention can be applied by any convenient means. Those skilled in the art are familiar with the modes of application that include foliar applications such as spraying, chemigation (a process of applying the mixture through the irrigation system) or by granular application.

The compositions of the present invention can be prepared as concentrate formulations, as ready-to-use formulations or as a tank mix.

In another embodiment, the present invention is further directed to a method of controlling weeds comprising applying concurrently or sequentially a PPO inhibitor and one or more fertilizers comprising a sugar alcohol selected from the group consisting of mannitol and sorbitol and optionally, one or more auxin herbicides to the weeds or an area in need of weed control.

In a preferred embodiment, the PPO inhibitor may be applied at a rate from about 1 to about 1,000 grams per hectare (“g/HA”), more preferably from about 1 to about 100 g/HA and even more preferably from about 10 to about 50 g/HA and yet even more preferably from about 10 to about 30 g/HA and most preferably at about 20 g/HA.

In another preferred embodiment, the one or more fertilizers comprising a sugar alcohol selected from the group consisting of mannitol and sorbitol may be applied at a rate from about 1 to about 100 liters per hectare (“L/HA”), more preferably from about 2 to about 50 L/HA and even more preferably from about 5 to about 20 L/HA, yet even more preferably from about 12 to about 16 L/HA and most preferably at about 14 L/HA.

In another preferred embodiment, the one or more auxin herbicides may be applied at a rate from about 1 to about 1,000 g/HA, more preferably from about 10 to about 100 g/HA.

In another embodiment, the weed controlled by the compositions of the present invention is at least one of Waterhemp (Amaranthus tuberculatus), Horseweed (Conyza Canadensis), Ivyleaf Morningglory (Ipomoea hederacea), Pitted Morningglory (Ipomoea lacunose), Common Ragweed (Ambrosia artemisiifolia), Giant Ragweed (Ambrosia trifida), Large Crabgrass (Digitaria sanguinalis), Palmer Amaranth (Amaranthus palmeri), Broadleaf Signalgrass (Brachiaria platyhylla), Common Barnyardgrass (Echinochloa crus-galli), Yellow Nutsedge (Cyperus esculentus), Eclipta (Eclipta prostrate), Lambsquarters (Chenopodium species), Velvetleaf (Abutilon theophrasti), Foxtail (Setaria species), Giant Foxtail (Setaria faberi), Volunteer Corn (Zea mays) and annual grasses. As used herein, annual grasses include corn, sorghums, wheat, rye, barley, and oats. In a preferred embodiment, the weed controlled is selected from the group consisting of common barnyardgrass, broadleaf grass and volunteer corn.

In another embodiment, the area in need of weed control may include any area that is desired to have a reduced number of weeds or to be free of weeds. For example, compositions of the present invention may be applied to an area used to grow crop plants, such as a field orchard, or vineyard. Mixtures of the present invention can also be applied to non-agricultural areas in need of weed control such as lawns, golf courses, or parks.

As used herein, all numerical values relating to amounts, weight percentages and the like are defined as “about” or “approximately” each particular value, plus or minus 10%. For example, the phrase “at least 5.0% by weight” is to be understood as “at least 4.5% to 5.5% by weight.” Therefore, amounts within 10% of the claimed values are encompassed by the scope of the claims.

Throughout the application, the singular forms “a,” “an,” and “the” include plural reference unless the context clearly dictates otherwise.

These representative embodiments are in no way limiting and are described solely to illustrate some aspects of the invention.

Further, the following examples are offered by way of illustration only and not by way of limitation.

### EXAMPLES

Agridex® is a crop oil concentrate and is a registered trademark of and available from Bayer CropScience.

Intact™ contains 43.18% polyethylene glycol, choline chloride and guar gum and is available from Precision laboratories.

Manni-Plex® FE was used as the source of mannitol and/or sorbitol comprising fertilizer. Manni-Plex is available from and a registered trademark of Brandt Consolidated, Inc.

### Example 1—Mannitol and/or Sorbitol Comprising Fertilizers Increase Performance of S-3100 in Barnyard Grass

4 trials were conducted on the efficacy of ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (“S-3100”) with or without a mannitol and/or sorbitol comprising fertilizer. Specifically, 4 pots of barnyard grass were grown to 10 inches in height. These pots were placed in a spray chamber for treatment. All compositions contained 1% v/v of Agridex®. The composition containing S-3100 and fertilizer contained 1% v/v of Intact™. Treatments and results can be found in Table 1, below.

TABLE 1

| | | Days After | | |
|---|---|---|---|---|
| | | Treatment | | |
| | Application Rate | (% control) | | |
| Treatment | (per Hectare) | 3 | 7 | 13 |
| Untreated | 0 | 0 | 0 | 0 |
| Control | | | | |
| S-3100 | 20 grams | 73.3 | 85.2 | 84.7 |
| Fertilizer | 14 liters | 0 | 0 | 10 |
| S-3100 | 20 grams | 88.7 | 93.2 | 88.0 |
| Fertilizer | 14 liters | | | |

As seen in Table 1, above, at 3 days after treatment (“DAT”) there was more than a 15% increase in control of barnyard grass by S-3100 and fertilizer (88.7%) compared to S-3100 alone (73.3%). At 7 DAT, S-3100 and fertilizer (93.2%) demonstrated almost an 8% increase in control of barnyard grass compared to S-3100 treatment alone (85.2%).

Improved residual control was also observed at 13 DAT. At 13 DAT, S-3100 and fertilizer (88.0%) demonstrated an increase in control of barnyard grass compared to S-3100 alone (84.7%). Increased activity was observed as increased speed of contract burn, more complete kill and less regrowth of barnyard grass plants.

### Example 2—Mannitol and/or Sorbitol Comprising Fertilizers Increase Performance of S-3100 in Broadleaf Grass

4 trials were conducted on the efficacy of ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (“S-3100”) with or without a mannitol and/or sorbitol comprising fertilizer. Specifically, 4 pots of broadleaf grass were grown to 10 inches in height. These pots were placed in a spray chamber for treatment. All compositions contained 1% v/v of Agridex®. The composition containing S-3100 and fertilizer contained 1% v/v of Intact™. Treatments and results can be found in Table 2, below.

TABLE 2

| | | Days After | | |
|---|---|---|---|---|
| | | Treatment | | |
| | Application Rate | (% control) | | |
| Treatment | (per Hectare) | 3 | 7 | 14 |
| Untreated | 0 | 0 | 0 | 0 |
| Control | | | | |
| S-3100 | 20 grams | 75.0 | 93.0 | 84.2 |
| Fertilizer | 14 liters | 10 | 10 | 10 |
| S-3100 | 20 grams | 91.7 | 95.8 | 95.8 |
| Fertilizer | 14 liters | | | |

As seen in Table 2, above, at 3 days after treatment (“DAT”) there was nearly a 17% increase in control of broadleaf grass by S-3100 and fertilizer (91.7%) compared to S-3100 alone (75.0%). At 7 DAT, S-3100 and fertilizer (95.8%) demonstrated nearly a 3% increase in control of broadleaf grass compared to S-3100 treatment alone (93.0%).

Improved residual control was also observed at 14 DAT. At 14 DAT, S-3100 and fertilizer (95.8%) demonstrated over an 11% increase in control of broadleaf grass compared to S-3100 alone (84.2%). Increased activity was observed as increased speed of contract burn, more complete kill and less regrowth of broadleaf grass plants.

### Example 3—Mannitol and/or Sorbitol Comprising Fertilizers Increase Performance of S-3100 in Giant Foxtail

4 trials were conducted on the efficacy of ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (“S-3100”) with or without a mannitol and/or sorbitol comprising fertilizer. Specifically, 4 pots of giant foxtail were grown to 10 inches in height. These pots were placed in a spray chamber for treatment. All compositions contained 1% v/v of Agridex®. The composition containing S-3100 and fertilizer contained 1% v/v of Intact™. Treatments and results can be found in Table 3, below.

TABLE 3

| | | Days After | | |
|---|---|---|---|---|
| | | Treatment | | |
| | Application Rate | (% control) | | |
| Treatment | (per Hectare) | 3 | 7 | 14 |
| Untreated | 0 | 0 | 0 | 0 |
| Control | | | | |
| S-3100 | 20 grams | 76.7 | 95.5 | 96.1 |
| Fertilizer | 14 liters | 0 | 10 | 0 |
| S-3100 | 20 grams | 71.7 | 95.2 | 94.0 |
| Fertilizer | 14 liters | | | |

As seen in Table 3, above, at 3, 7 and 14 days after treatment (“DAT”) the addition of a mannitol comprising fertilizer to S-3100 maintained control of giant foxtail.

### Example 4—Mannitol and/or Sorbitol Comprising Fertilizers Increase Performance of S-3100 in Volunteer Corn

4 trials were conducted on the efficacy of ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (“S-3100”) with or without a mannitol and/or sorbitol comprising fertilizer. Specifically, 4 pots of volunteer corn were grown to 15 inches in height. These pots were placed in a spray chamber for treatment. All compositions contained 1% v/v of Agridex®. The composition containing S-3100 and fertilizer contained 1% v/v of Intact™. Treatments and results can be found in Table 4, below.

TABLE 4

| | | Days After | | |
|---|---|---|---|---|
| | | Treatment | | |
| | Application Rate | (% control) | | |
| Treatment | (per Hectare) | 3 | 7 | 14 |
| Untreated | 0 | 0 | 0 | 0 |
| Control | | | | |
| S-3100 | 20 grams | 65.0 | 59.2 | 56.7 |
| Fertilizer | 14 liters | 8.3 | 5.0 | 10.0 |
| S-3100 | 20 grams | 83.3 | 95.3 | 95.2 |
| Fertilizer | 14 liters | | | |

As seen in Table 4, above, at 3 days after treatment (“DAT”) there was more than an 18% increase in control of volunteer corn by S-3100 and fertilizer (93.3%) compared to S-3100 alone (65.0%). At 7 DAT, S-3100 and fertilizer (95.3%) demonstrated a 36% increase in control of volunteer corn compared to S-3100 treatment alone (59.2%).

Improved residual control was also observed at 14 DAT. At 14 DAT, S-3100 and fertilizer (95.2%) demonstrated more than a 38% increase in control of volunteer corn compared to S-3100 alone (56.7%). Increased activity was observed as increased speed of contract burn, more complete kill and less regrowth of volunteer corn.

What is claimed is:

1. An agricultural composition comprising a protoporphyrinogen oxidase (PPO) inhibitor and one or more fertilizers comprising a sugar alcohol selected from the group consisting of mannitol and sorbitol.

2. The composition of claim 1, wherein the PPO inhibitor is selected from the group consisting of ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate, flumioxazin, lactofen, fomesafen, saflufenacil, sulfentrazone and trifludimoxazin.

3. The composition of claim 2, wherein the PPO inhibitor is ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate.

4. The composition of claim 1, wherein the one or more fertilizers further comprise nitrogen and iron.

5. The composition of claim 4, wherein the one or more fertilizers comprise about 5% w/v nitrogen and about 5% w/v iron, wherein w/v denotes weight by total volume of the composition.

6. The composition of claim 1, further comprising one or more auxin herbicides.

7. The composition of claim 6, wherein the one or more auxin herbicides is selected from the group consisting of dicamba, 2,4-D, dichloroprop, (4-chloro-2-methylphenoxy)acetic acid (MCPA), 4-(4-chloro-2 methylphenoxy)butanoic acid (MCPB), mecoprop, picloram, quinclorac, triclopyr, fluroxypyr, picloram, aminopyralid, clopyralid and aminocyclopyrachlor and agricultural acceptable salts and esters thereof.

8. The composition of claim 7, wherein the one or more auxin herbicides is a salt of dicamba.

9. The composition of claim 8, where in the salt of dicamba is selected from the group consisting of dicamba-biproamine, dicamba-diglycolamine, and dicamba-tetrabutylamine.

10. An agricultural composition comprising ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate and a fertilizer comprising mannitol, nitrogen and iron.

11. The composition of claim 10, further comprising a salt of dicamba.

12. A method of controlling weeds comprising applying concurrently or sequentially a protoporphyrinogen oxidase (PPO) inhibitor and one or more fertilizers comprising a sugar alcohol selected from the group consisting of mannitol and sorbitol to the weeds or an area in need of weed control.

13. The method of claim 12, further comprising applying concurrently or sequentially one or more auxin herbicides to the weeds or an area in need of weed control.

14. The method of claim 12, wherein the PPO inhibitor is applied at a rate from about 1 to about 100 grams per hectare.

15. The method of claim 12, wherein the PPO inhibitor is applied at a rate from about 10 to about 50 grams per hectare.

16. The method of claim 12, wherein the PPO inhibitor is applied at a rate of 20 grams per hectare.

17. The method of claim 12, wherein the one or more fertilizers comprising a sugar alcohol selected from the group consisting of mannitol and sorbitol is applied at a rate about 100 to about 100,000 grams per hectare.

18. The method of claim 12, wherein the one or more sugar alcohols is applied at a rate about 1,000 to about 30,000 grams per hectare.

19. The method of claim 12, wherein the one or more fertilizers comprising a sugar alcohol selected from the group consisting of mannitol and sorbitol is applied of about 6,800 grams per hectare.

20. The method of claim 13, wherein the one or more auxin herbicides is applied at a rate about 1 to about 1,000 grams per hectare.
